(19) United States
(12) Patent Application Publication
(10) Pub. No.: US 2016/0189843 A1
(43) Pub. Date: Jun. 30, 2016

(54) MAGNETIC ADAPTER ASSEMBLY

(71) Applicant: METAL INDUSTRIES RESEARCH AND DEVELOPMENT CENTRE, Kaohsiung (TW)

(72) Inventors: Yu-Min TING, Kaohsiung (TW); Tung-Chieh YANG, Kaohsiung (TW); Yu-Fen KUO, Kaohsiung (TW); Yan-Jun CHEN, Kaohsiung (TW); Tsung-Chih YU, Kaohsiung (TW); Ho-Chung FU, Kaohsiung (TW)

(21) Appl. No.: 14/584,452

(22) Filed: Dec. 29, 2014

(51) Int. Cl. H01F 7/02

(52) U.S. Cl. CPC H01F 7/0221

(57) ABSTRACT

A magnetic adapter assembly for connection with at least one magnetic excitation device includes a magnetic adapter which includes an insulating housing having a plurality of connection portions facing in different directions, a magnetic unit disposed in the insulating housing and having a plurality of positioning grooves respectively aligned with the connection portions for allowing extension of the magnetic excitation device into one of the positioning grooves through a selected one of the connection portions, and at least one fastener for fastening together the magnetic excitation device and one of the connection portions.

### FIELD OF THE INVENTION

The invention relates to an adapter, more particularly to a magnetic adapter assembly that can permit various types of combinations and expansions of magnetic excitation devices of a magnetic thermal ablation system.

### BACKGROUND OF THE INVENTION

The present cancer curing method, such as microwave hyperthermia, radiofrequency ablation hyperthermia, etc., employs ablation to cause necrosis of tumor tissues, thereby achieving the purpose of cancer treatment. However, the cost of the conventional treatment for tumor ablation is rather high, so that many patients have not undergone cancer treatments.

Following today's upgrading of medical standards, a new magnetic thermal tumor ablation technology for cancer treatment is developed. This technology mainly uses an alternating magnetic field to act on a magnetic needle, so that the magnetic needle generates an eddy current that is converted into heat to ablate the tumor tissues. This approach can significantly reduce the treatment cost and the patient suffering. However, how to control the magnetic field is a key element for determining the treatment quality. Hence, there is still a must to rely on continuous improvement of research and development of the technology.

Referring to FIG. 1, a conventional magnetic hyperthermia equipment is shown to mainly include a stand 11, a magnetic control device 12 mounted on the stand 11, a coil 13 connected electrically to the magnetic control device 12, a cooling water circulating device 14 connected to the magnetic control device 12, and a central control device 15 connected electrically to the magnetic control device 12 and the cooling water circulating device 14. For a shallow hyperthermia treatment, the coil 13 is first placed on a patient's body, after which a magnetic needle is passed through the coil 13 which is energized to generate a high frequency magnetic field. The magnetic field, in turn, induces the magnetic needle to generate heat for ablating the tumor tissues. For a deep hyperthermia treatment, two magnetic hyperthermia equipments must be prepared, and the coils 13 of the magnetic hyperthermia equipments are respectively placed above and below a to-be-treated portion of the patient. Then, through the high frequency magnetic field generated by the coils 13 when the magnetic control devices are energized, the magnetic needle is induced to generate heat for ablating the tumor tissues. However, the positioning structure of the coils 13 of the conventional magnetic hyperthermia equipment is rather inconvenient to use. Only the height of the coils 13 or the distance therebetween can be manually adjusted, so that the distance between the coil 13 and the magnetic needle cannot be accurately controlled. Thus, it is hard to adjust the position of the coils 13 relative to an action angle of the magnetic field of the magnetic needle according to the treatment requirement.

Further, the current magnetic hyperthermia equipment requires the use of the cooling water circulating device 14, so that it is bulky and is not easy to transport. Moreover, the current magnetic hyperthermia equipment has many winding wires and water pipes which may hinder the treatment process. In addition, when the coils 13 of the two magnetic hyperthermia equipments are simultaneously used for treatment, the magnetic fields thereof cannot be easily matched.

### SUMMARY OF THE DISCLOSURE

Therefore, an object of this invention is to provide a magnetic adapter assembly that can permit various types of combinations and expansions of magnetic excitation devices of a magnetic thermal ablation system for providing more applications thereof.

According to this invention, a magnetic adapter assembly for connection with at least one magnetic excitation device comprises at least one magnetic adapter which includes an insulating housing, a magnetic unit and at least one fastener. The insulating housing includes a plurality of connection portions facing in different directions. The magnetic unit is disposed in the insulating housing, and has a plurality of positioning grooves respectively aligned with the connection portions for allowing extension of the magnetic excitation device into one of the positioning grooves through a selected one of the connection portions. The at least one fastener is used for fastening the magnetic excitation device to one of the connection portions.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a conventional magnetic hyperthermia equipment;

FIG. 2 is an exploded perspective view of a magnetic adapter of a magnetic adapter assembly according to the first embodiment of the present invention;

FIG. 3 is a fragmentary sectional view of the magnetic adapter of FIG. 2 in an assembled state;

FIG. 4 is a schematic view of a magnetic thermal ablation system incorporating the magnetic adapter of the embodiment;

FIG. 5 is a fragmentary enlarged schematic view of a portion of FIG. 4;

FIG. 6 illustrates how two magnetic excitation devices of the magnetic thermal ablation system are connected to the magnetic adapter of the embodiment;

FIG. 7 is a fragmentary sectional view of FIG. 6;

FIG. 8 is a schematic view, illustrating the magnetic adapter of the embodiment being applied to the magnetic thermal ablation system in a suspended manner;

FIG. 9 is a perspective view of the magnetic thermal ablation system incorporating the magnetic adapter assembly according to the second embodiment of this invention;

FIG. 10 illustrates a magnetic bar interconnecting two magnetic adapters; and

FIG. 11 is a circuit diagram of FIG. 10.

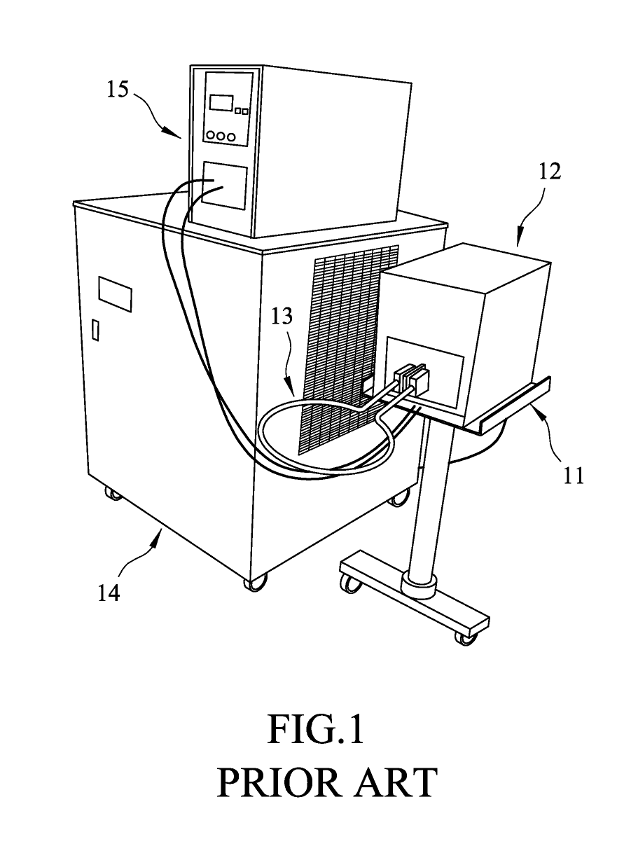

### DETAILED DESCRIPTION OF THE EMBODIMENTS

Before this invention is described in detail, it should be noted that, in the following description, similar elements are designated by the same reference numerals.

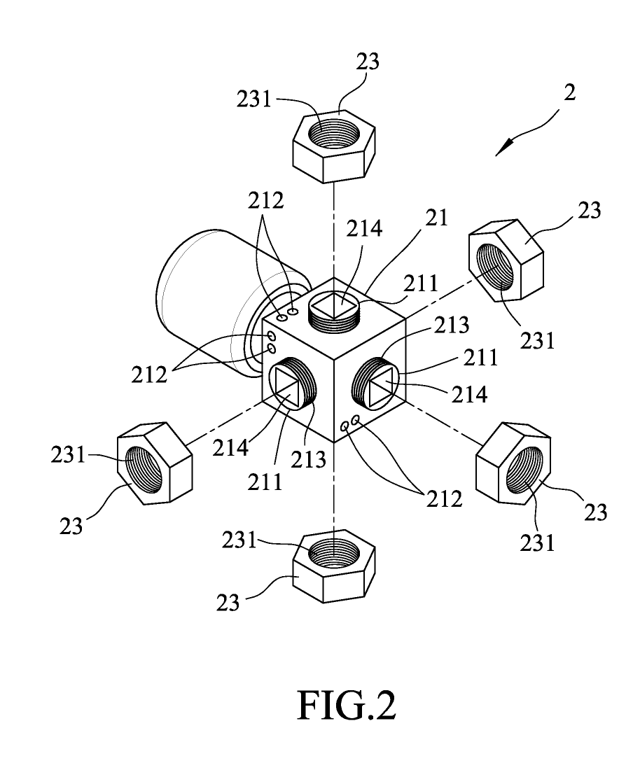

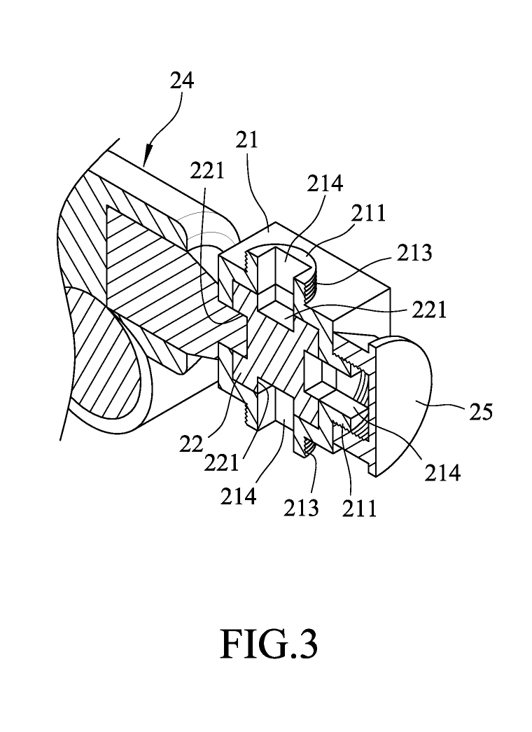

Referring to FIGS. 2 and 3, a magnetic adapter assembly according to the first embodiment of the present invention is shown to comprise a magnetic adapter 2 which includes an insulating housing 21, a magnetic unit 22, a plurality of fasteners 23 and a movable joint 24.

The insulating housing 21 is made of non-magnetic and non-conductive material, and includes a plurality of connection portions 211 and pairs of plug ports 212. The insulating housing 21 has a multi-sided body. The connection portions 211 protrude from an outer surface of the insulating housing 21 and face in different directions. Each of the connection portions 211 has an externally threaded member 213, and a non-threaded through hole 214 extending through the externally threaded member 213 for communicating an interior thereof with the ambiance. Each of the pairs of the plug ports 212 are disposed on the insulating housing 21 in proximity to a corresponding one of the connection portions 211.

The magnetic unit 22 is made of one of a highly magnetic monocrystalline, polycrystalline, and iron-based material. The magnetic unit 22 is disposed in the insulating housing 21, and has a plurality of positioning grooves 221 respectively aligned with the connection portions 211. That is, the positioning grooves 221 are respectively registered with the through holes 214 of the connection portions 211.

Each of the fasteners 23 has a ring body formed with an internal thread 231. The movable joint 24 has two opposite ends, one of which is inserted into one of the positioning grooves 221 through a corresponding one of the connection portions 211. The magnetic adapter 2 further includes a plurality of caps 25 for threadedly and respectively connecting the connection portions 211 so as to seal the through holes 214 thereof.

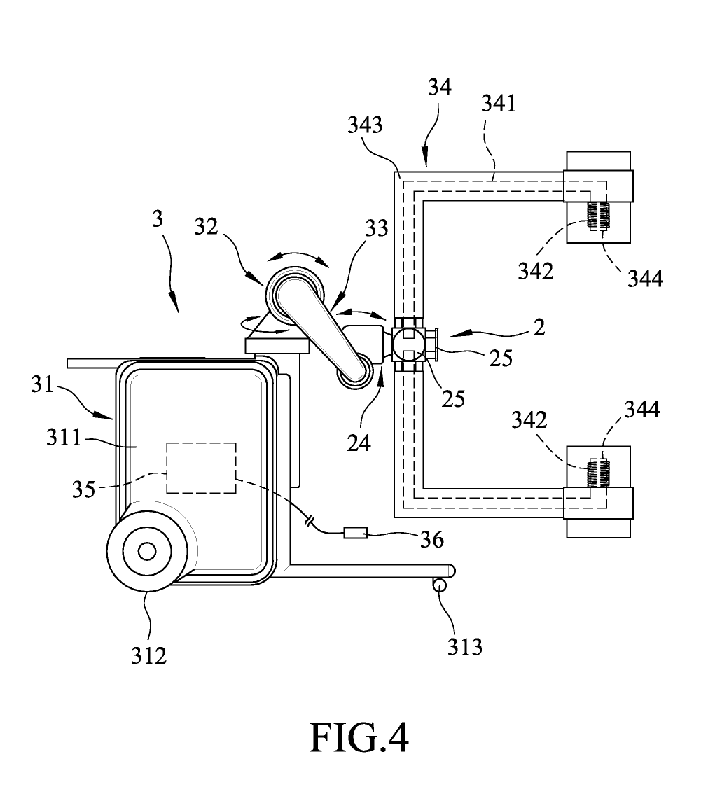

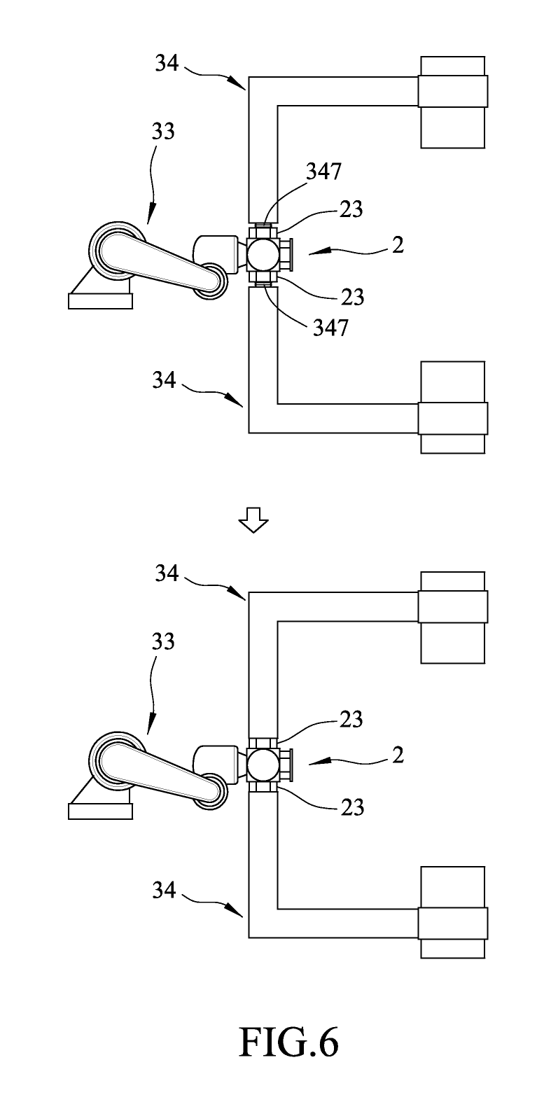

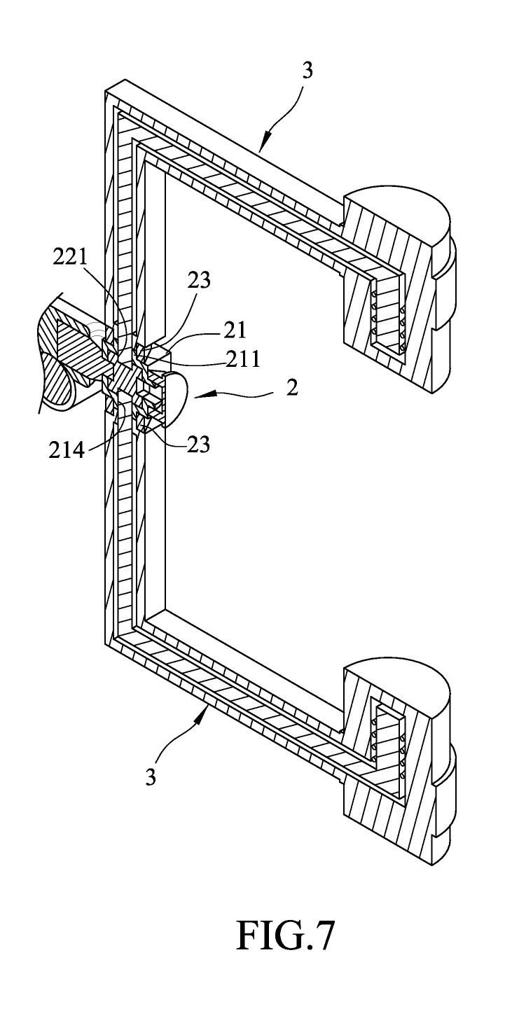

Referring to FIGS. 4 to 7, a magnetic thermal ablation system 3 is shown to incorporate the magnetic adapter 2 of the magnetic adapter assembly of this invention. The magnetic thermal ablation system 3 includes a carrier unit 31, a universal rotation unit 32, a cantilever unit 33, at least one magnetic excitation device 34, a control unit 35 and an input unit 36. The carrier unit 31 includes a carrier body 311 and a plurality of roller wheels 312, 313 provided on a bottom portion of the carrier body 311. The universal rotation unit 32 is pivoted to the carrier unit 31 and is rotatable 360 degrees relative to the carrier unit 31. The cantilever unit 33 has one end portion pivoted to the universal rotation unit 32, and another end portion connected to the other end of the movable joint 24.

As shown in FIG. 4, two magnetic excitation devices 34 are connected to the magnetic adapter 2.

However, the number of the magnetic excitation device 34 may be varied according to the actual requirement. Each of the magnetic excitation devices 34 includes a magnetic body 341, a coil 342, and an insulating shell 343 that is made of a non-magnetic, non-conductive, non-magnetic shield and high temperature resistant material and that is used to encapsulate the magnetic body 341 and the coil 342. The magnetic body 341 is made of one of a highly magnetic monocrystalline, polycrystalline and iron-based material, and may have a C-shaped, U-shaped, inverted U-shaped or L-shaped body. In this embodiment, an L-shaped magnetic body 341 is illustrated. The magnetic body 341 has a magnetic excitation end 344 and a connecting end 345. The connecting end 345 has an insert portion 346, and an external thread portion 347 proximal to the insert portion 346. The insert portion 346 is also made of one of a highly magnetic monocrystalline, polycrystalline and iron-based material.

The coil 342 is wrapped around the magnetic excitation end 344 of the magnetic body 341, and has a pair of terminals (not shown). The coil 342 may be wrapped around the magnetic excitation end 344 in different manners, for example, a tight single layer manner, an equal manner, a tight multi-layer manner, etc.

The control unit 35 is disposed in an interior of the carrier unit 31. A user can input control instructions through the input unit 36, so that the control unit 35 can control rotation of the universal rotation unit 32.

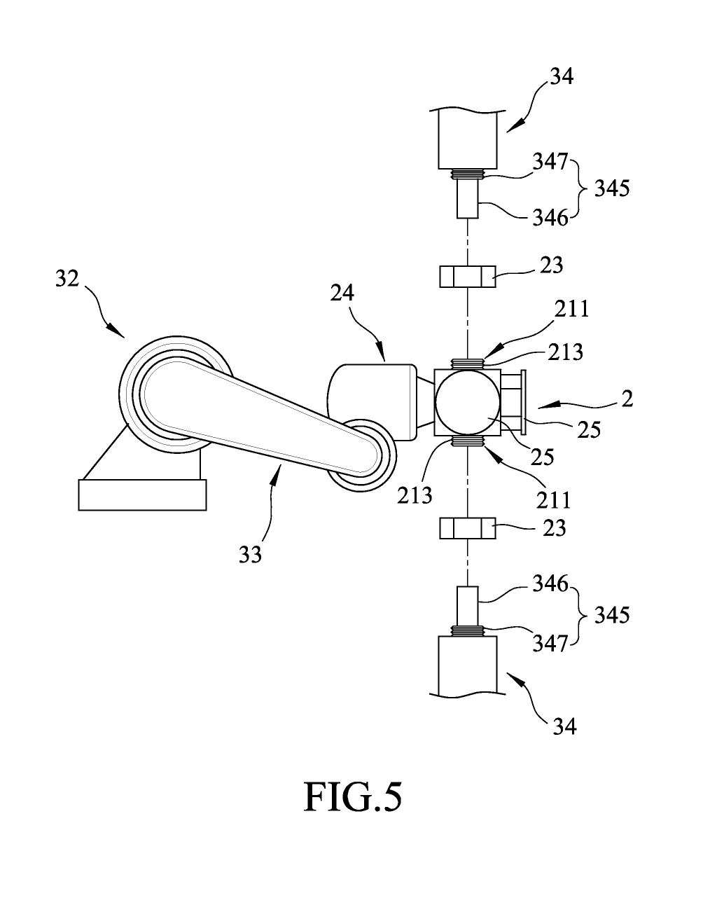

With reference to FIGS. 5 to 7, to assemble and position each magnetic excitation device 34 on the insulating housing 21 of the magnetic adapter 2, the insert portion 346 of the connecting end 345 of the magnetic body 341 of each magnetic excitation device 34 is first inserted into one of the positioning grooves 221 through the through hole 214 of a selected one of the connection portions 211, after which the internal thread 231 of a corresponding fastener 23 is threadedly engaged to both of the externally threaded member 213 of the selected one of the connection portions 211 and the external thread portion 347 of the connecting end 345 of the magnetic body 341 of the corresponding magnetic excitation device 34.

Further, the pair of the terminals of the coil 342 of each magnetic excitation device 34 are inserted into the pair of the plug ports 212 (see FIG. 2) that are proximate to the selected one of the connection portions 211, and are connected electrically to the control unit 35.

Referring again to FIG. 4, the user can then input control instructions through the input unit 36 so that the control unit 35 can control rotation of the universal rotation unit 32. Simultaneously, the cantilever unit 33 is moved to displace the magnetic adapter 2, thereby changing the positions of the magnetic excitation devices 34. Through this, the subsequent thermal ablation treatment can be facilitated.

It should be noted herein that, with the caps 25 sealing the through holes 214 of the idle ones of the connection portions 211 of the insulating housing 21, intrusion and accumulation of dirt or dust into the magnetic adapter 2 can be prevented.

It is worth to mention herein that, with the provision of the magnetic adapter 2, an appropriate number of the magnetic excitation devices 34 can be assembled to the magnetic adapter 2 in accordance with the requirement of the thermal ablation treatment by following the aforesaid assembling steps. Thus, the magnetic excitation devices 34 can be easily assembled and expanded. Further, with the magnetic excitation devices 34 being assembled to the magnetic adapter 2 at the selected ones of the connection portions 211, the convenience of treatment operation can be facilitated and the effect of the treatment can be enhanced.

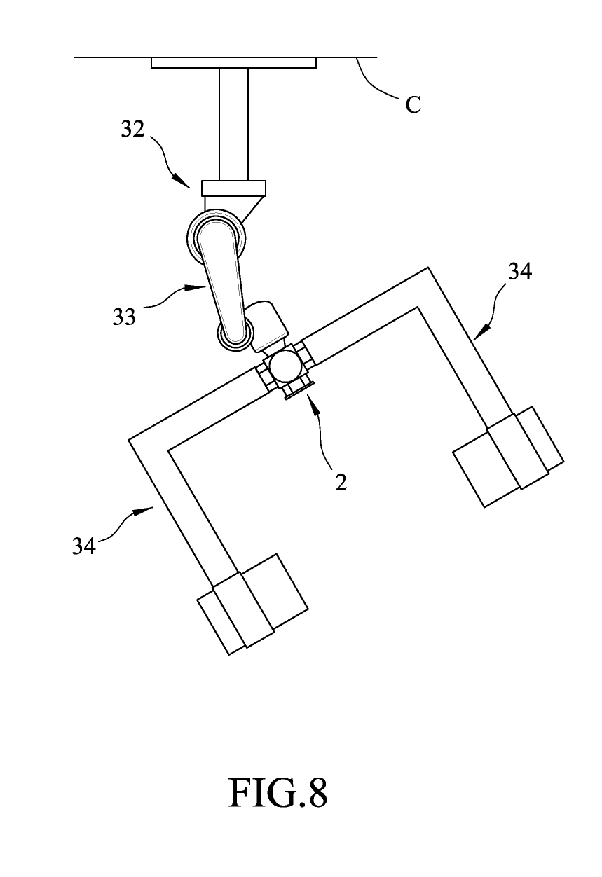

The magnetic adapter 2 may be mounted in a suspended manner according to the different structural design of the magnetic thermal ablation system 3. The magnetic thermal ablation system 3, as shown in FIG. 8, is dispensed with the carrier unit 31, the universal rotation unit 32 is directly connected to a ceiling (C), and the magnetic adapter 2 is suspended below the ceiling (C). As for the control unit of the magnetic thermal ablation system 3, it maybe placed on a holding surface at one side thereof. Another implementation of this disclosure can thus be provided.

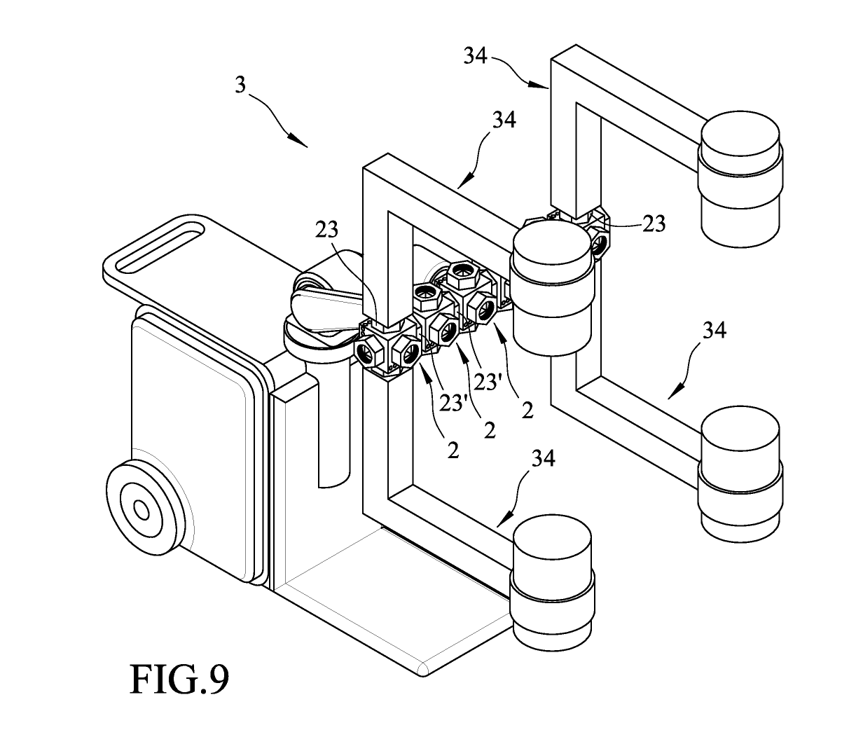

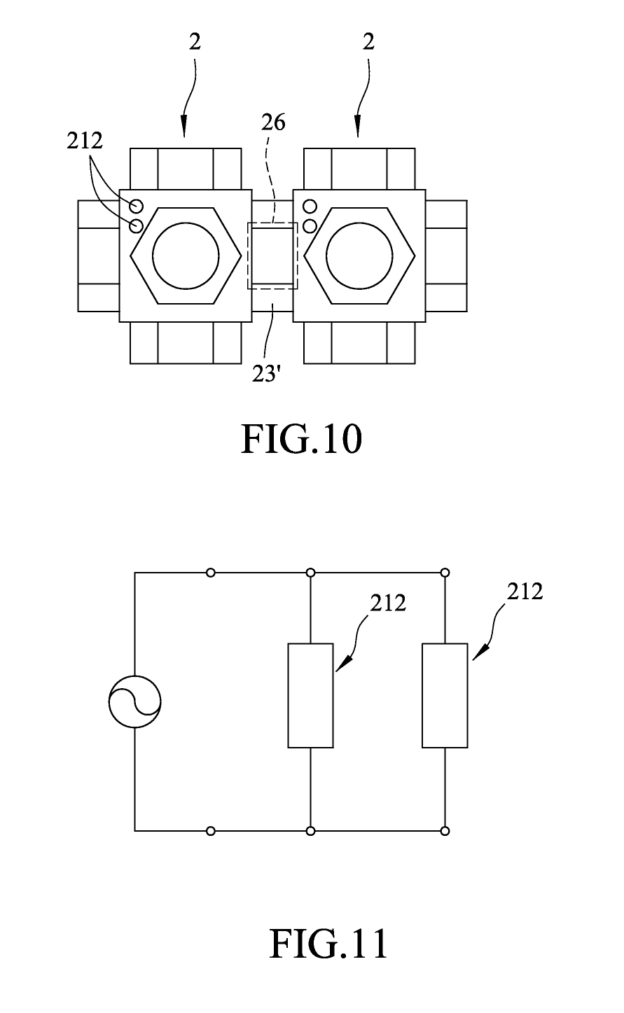

Referring to FIGS. 9 and 10, a magnetic adapter assembly according to the second embodiment of the present invention is shown incorporated in the magnetic thermal ablation system 3, and is shown to include a plurality of the magnetic adapters 2 and a plurality of adapter connection units. Each of the adapter connection units includes a magnetic bar 26 and a coupling member 23′. The magnetic bar 26 has two opposite ends respectively inserted into the positioning groove 221 of one of the magnetic adapters 2 through one of the connection portions 211 thereof and the positioning groove 221 of an adjacent one of the magnetic adapters 2 through a corresponding one of the connection portions 211 thereof. The coupling member 23′ is sleeved around and threadedly engaged to the one of the connection portions 211 of the one of the magnetic adapters 2 and the corresponding one of the connection portions 211 of the adjacent magnetic adapter 2. Through this, the magnetic adapters 2 can be connected in parallel, and a plurality of the magnetic excitation devices 34 can be assembled to the connection portions 211 of the magnetic adapters 2 at appropriate positions.

With the pair of the terminals of the coil 342 of each magnetic excitation device 34 inserted into a corresponding pair of the plug ports 212, the plug ports 212 can be connected in parallel, as shown in FIG. 11, and can be electrically connected to a power source provided by the magnetic thermal ablation systems 3 for supplying the required power and for generating an alternating magnetic field. Hence, the magnetic excitation devices 34 of the magnetic thermal ablation system 3 can have different types of combinations and expansions for different treatment applications.

In sum, through the aforesaid structural design of the magnetic adapter assembly of this invention, each connection portion 211 can permit connection with one of the magnetic excitation devices 34. Further, two adjacent ones of the magnetic adapters 2 can be connected in parallel by inserting the two opposite ends of the magnetic bar 26 into the positioning groove 221 of one of the magnetic adapters 2 and the positioning groove 221 of the adjacent magnetic adapter, after which the coupling member 23′ is threadedly engaged to one of the connection portions 211 of the one of the magnetic adapters 2 and the corresponding one of the connection portions 211 of the adjacent magnetic adapter 2. As such, when use in medical treatment, the magnetic thermal ablation system 3 can have different types of combinations and expansions to meet different treatment applications. Moreover, the magnetic adapter 2 may be manufactured in a modular manner, so that the method is simple and the cost thereof can be reduced. As a result, more applications may be developed. Therefore, the object of this disclosure can be achieved.

While the disclosure has been described in connection with what are considered the most practical embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A magnetic adapter assembly for connection with at least one magnetic excitation device, said magnetic adapter assembly comprising:
at least one magnetic adapter including
an insulating housing including a plurality of connection portions facing in different directions;
a magnetic unit disposed in said insulating housing and having a plurality of positioning grooves respectively aligned with said connection portions for allowing extension of the magnetic excitation device into one of said positioning grooves through a selected one of said connection portions; and
at least one fastener for fastening the magnetic excitation device to one of said connection portions.

2. The magnetic adapter assembly as claimed in claim 1, further comprising a movable joint having one end extending into another one of said positioning grooves through another selected one of said connection portions.

3. The magnetic adapter assembly as claimed in claim 1, wherein the magnetic excitation device includes a magnetic body having a magnetic excitation end, and a coil wrapped around the magnetic excitation end and having a pair of terminals, and wherein said insulating housing further includes pairs of plug ports, each of said pairs of said plug ports being disposed on said insulating housing in proximity to a corresponding one of said connection portions for insertion of and electrical connection with the pair of the terminals of the coil of the magnetic excitation device that is inserted into the selected one of said connection portions.

4. The magnetic adapter assembly as claimed in claim 1, wherein each of said connection portions has an externally threaded member, and a non-threaded through hole extending through said externally threaded member and registered with a respective one of said positioning grooves, said at least one fastener having a ring body formed with an internal thread to engage said externally threaded member.

5. The magnetic adapter assembly as claimed in claim 4, wherein the magnetic body of the magnetic excitation device further has a connecting end, the connecting end having an insert portion, and an external thread portion proximal to the insert portion, and wherein the insert portion of the magnetic body of the magnetic excitation device is able to extend into the selected one of said connection portions, and said internal thread of said at least one fastener is able to threadedly engage both of said externally threaded member of the selected one of said connection portions and the external thread portion of the connecting end of the magnetic excitation device for assembling the magnetic excitation device on said insulating housing.

6. The magnetic adapter assembly as claimed in claim 5, further comprising a plurality of caps for threadedly and respectively connecting said connection portions so as to seal said through holes of said connection portions.

7. The magnetic adapter assembly as claimed in claim 1, wherein said magnetic unit is made of one of a highly magnetic monocrystalline, polycrystalline and iron-based material, and said insulating housing is made of a non-magnetic and non-conductive material.

8. The magnetic adapter assembly as claimed in claim 1, wherein said at least one magnetic adapter includes at least two said magnetic adapters, said magnetic adapter assembly further comprising an adapter connection unit to interconnect said magnetic adapters, said adapter connection unit connecting one of said connection portions of one of said magnetic adapters to one of said connection portions of the other one of said magnetic adapters.

9. The magnetic adaptor assembly as claimed in claim 8, wherein said adapter connection unit includes a magnetic bar having two opposite ends respectively inserted into said one of said connection portions of said one of said magnetic adapters and said one of said connection portions of the other one of said magnetic adapters, and a coupling member sleeved around and threadedly engaged to said one of said connection portions of said one of said magnetic adapters and said one of said connection portions of the other one of said magnetic adapters.
